(19) United States
(12) Patent Application Publication
(10) Pub. No.: US 2004/0040041 A1
(43) Pub. Date: Feb. 26, 2004

(54) Interactive applications for stored video playback

(75) Inventor: Jeffrey D. Crawford, San Francisco, CA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA (US)

(21) Appl. No.: 10/225,949

(22) Filed: Aug. 22, 2002

(51) Int. Cl. H04N 7/173; H04N 7/16

(52) U.S. Cl. 725/88; 725/89; 725/141

(57) ABSTRACT

An interactive application uses Digital Video Record (DVR) features to create one or more video segments and associated indexes from broadcast television programming. The video segments and associated indexes may be obtained from independent sources and, in any event, are used by the application to create an enhanced programming viewing experience.

### FIELD OF THE INVENTION

The present invention generally relates to an interactive application created for entertainment systems and services, and more particularly, the invention relates to an interactive application that integrates one or more recorded video segments in a logical fashion to create an enhanced viewing experience.

### BACKGROUND OF THE INVENTION

Television programming has conventionally provided viewers a wide variety of entertainment, sports, news, advertisements and educational programming. Such services typically offer numerous television programs at any given time but the programming is primarily limited to the broadcast program itself without any other creative content associated therewith.

Certain interactive programming experiences have been provided through a set-top box, or other similar computing device. Such experiences are intended to enable a viewer to participate in or create a perception that the viewer is actually participating in the television broadcast. In some instances, interactive programming allows a viewer to play along with participants in a game show by simultaneously answering questions and accumulating prizes and the like. Interactive programming experiences sometimes allow viewers to obtain a more thorough understanding of a particular television broadcast. The set-top box enables such experiences by connecting with a Web site to obtain information relevant to a broadcast and then rendering the obtained content on a display in place of or in connection with the television broadcast. For example, the set-top box may connect to a sports-related Web site to obtain information such as a quarterback's passing efficiency rating or other statistics.

In addition to interactive programming, services such as digital video recording (DVR) have recently been made available. They now provide viewers a greater degree of freedom in viewing various television programs as desired and to permit ready navigation through such programs. While certain forms of interactive television programming and DVR services are known, it would be desirable to converge these services to provide additional features and alternative content to viewers.

### SUMMARY OF THE INVENTION

The present invention provides an enhanced television viewing experience by processing prerecorded video content. In one embodiment, the invention creates one or more indexes or locations of specific points in the video recording that correspond to the occurrence of specific events in the recording. The indexes are associated with the prerecorded video content to enable an enhanced viewing experience.

The invention also includes a software application that aggregates the video indicesand prerecorded video contentin some logical fashion. Thus, the invention may take on many forms. By way of example only, the application may associate indices with prerecorded video contentto create an enhanced highlight program that logically plays back the video recording beginning at a specific point in the recording, at an appropriate time, in the context of a new program. Alternatively, the invention may permit access to independent video data sources by categorizing programs received from independent sources. Next, the application causes categories of the recorded content to be displayed wherein receiving a selection of a category displays a play-list of captured video data related to the category. The application then plays back selected video data based on user interaction and selection thereof.

### BRIEF DESCRIPTION OF THE DRAWINGS

FIG. 1 is a block diagram representation of a client-server system in one operative environment of the present invention;

FIG. 2 is a block diagram representation of certain components that may be used the server-client system shown in services in the embodiments of FIG. 1;

FIG. 3 is a flow chart illustrating certain operational aspects of content aggregator and broadcast server components in the server architecture shown in FIG. 2;

FIG. 4 is a flow chart illustrating certain operational aspects of an application executing on the client system shown in FIG. 2 according to one embodiment of the invention;

FIG. 5 illustrates a User Interface that provides user selection of aggregated video segments obtained from independent sources according to the invention;

FIG. 6 illustrates another User Interface according to the invention;

FIG. 7 is a User Interface for an indexed football game according to the invention;

FIG. 8 is a User Interface for a Music Video application according to the invention; and

FIG. 9 is a User Interface for an Awards program application according to the invention.

### DETAILED DESCRIPTION OF THE INVENTION

The present invention relates to an interactive application and indexing data that are attached to previously recorded video content such as recorded broadcast television programming or the like. The indexing data is used to establish entry points to video locations that are aggregated in a logical fashion to create an enhanced viewing experience for users. The manner in which such video segments are created and indexed is further described in co-pending application Ser. No. 10/052,111, filed Jan. 17, 2002, entitled “Enhanced Television Services For Digital Video Recording And Playback,” which is a continuation-in-part of application Ser. No. 09/903,973, filed Jul. 12, 2001, entitled “Enhanced Television Services.” The subject matter of those applications is incorporated herein by reference in their entirety.

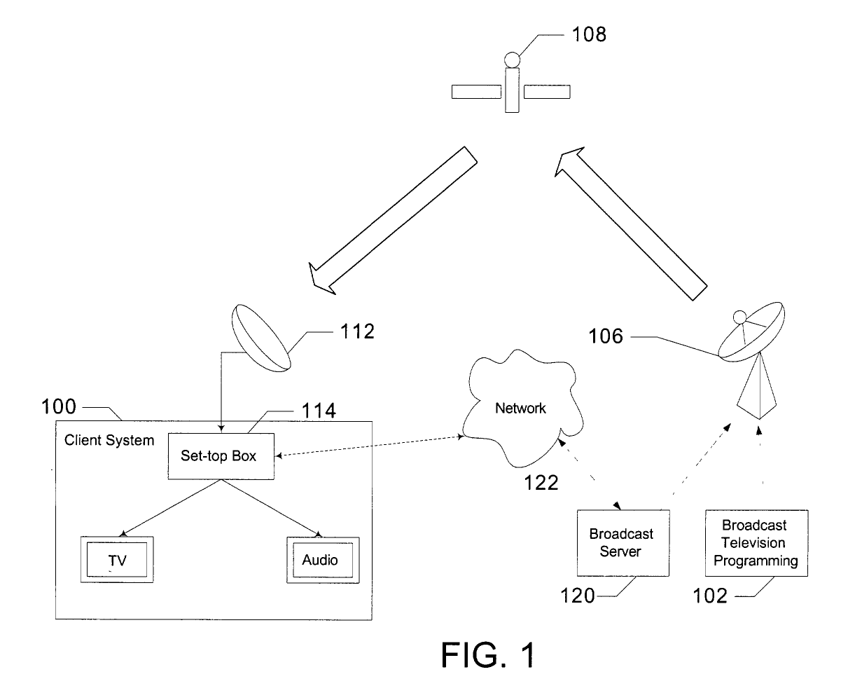

FIG. 1 illustrates a block diagram representation of a client-server system 10 according to the invention. In this embodiment, the invention is implemented as part of a digital satellite network that provides broadcast television and audio programming, and optionally other information over data broadcast channels. The network preferably supplies digital music content in a broadcast channel in the allocated bandwidth, along with other types of programming and data.

The digital satellite broadcast system 102 provides digital television programming and other data services that are broadcast to one or more client systems such as a client system 100. In particular, the available television programming is up-linked via a transmitter 106 to the satellite system 108 over a first communication channel. The programming is down-linked via a second data communication channel to a plurality of client systems, one of which is shown as client system 100. The client system includes receiver 112 that is coupled with a set-top box 114 or other similar computing device adapted to capture the programming as is understood by those skilled in the art.

In addition to the broadcast television programming, a Broadcast Server 120 generates an enhanced data stream, such as an IP content stream related to the programming. The parallel data stream is similarly up-linked to the satellite system 108. This content stream is down linked to the Client System 100 via the second communication channel.

As explained below, the Client System 100 comprises an advanced set-top box 114 or other similar computing device that demultiplexes, decodes and processes the data received from the antenna receiver 112. The client system 100 also includes a display device such as television receiver (TV). Alternate embodiments include Personal Digital Assistants (PDAs), cellular telephones and other computing devices, and optionally other audio/visual equipment. In addition to the audio system shown in FIG. 1, the client system may include an external digital video recorder (DVR) or other entertainment equipment.

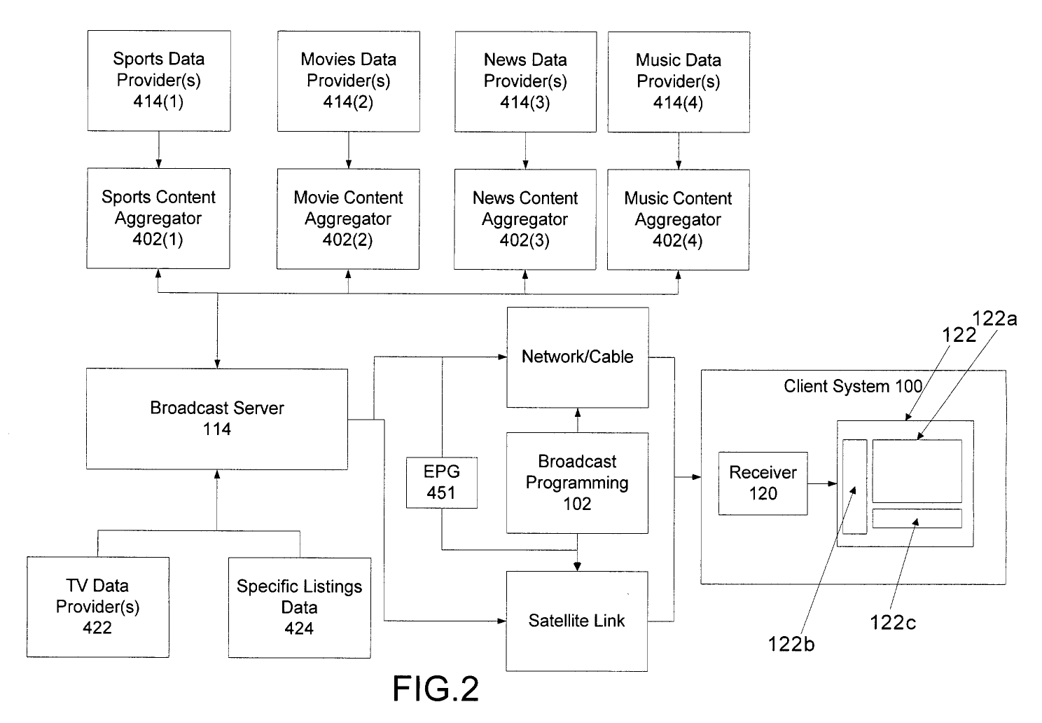

While FIG. 1 illustrates delivery of television programming via a satellite system, such programming may alternatively be delivered via a cable television system. In one embodiment of the invention, television programming is provided through a digital cable system that delivers multiple channels of video data in a compressed format, such as MPEG II format. Other broadcast television systems may be used through either (or both) a satellite link or through a network/cable system (see FIG. 2).

For both the satellite and digital cable embodiments, data services in the form of enhanced content are provided to the client systems, preferably in a dedicated data communication channel. In this embodiment, the Broadcast Server 120 or head-end pre-allocates the bandwidth to accommodate the data services in a channel or bundle of channels that are reserved for exclusive use of these services. However, data services may be transmitted in any manner. For example, the Playback application and associated index files may be sent from user to user through email or through other transmission media.

For each television program that is available, the service provides an Event Identifier. In one embodiment, then, an enhanced television schedule is created and periodically downloaded to the client systems. Each entry in the enhanced television schedule includes an Event Identifier, an event time and a market identifier corresponding to the channel number or tuner position for a particular local television market.

A data service provider and/or broadcast server create the enhanced content that is delivered to the client system. For example, a sports content aggregator creates a normalized data stream that includes an Event Identifier associated with each event, program or meta-data provided by external data providers. The content aggregator transmits the normalized data stream to a broadcast server. The normalized data stream preferably conforms the various data received by the content aggregator to an API being used by the broadcast server. The Broadcast Server then matches a local line-up data to the Event Ids being transmitted by the content aggregator to create a new thematic schedule indexed by Event ID. The content aggregator receives data from external sources that has no data ID or its own unique data ID.

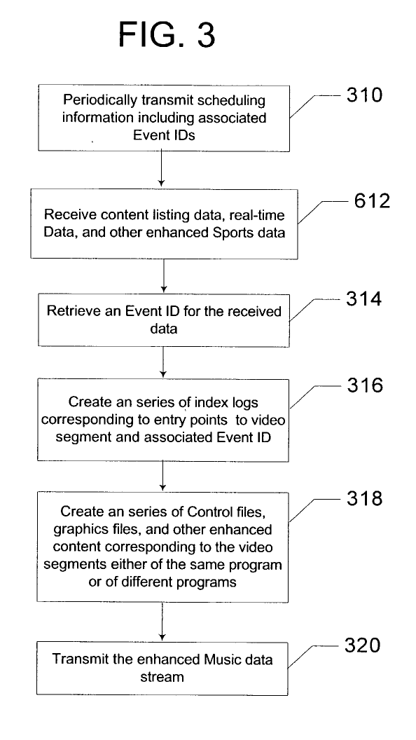

The Content Aggregator maps the data to a single Event ID system, and transmits the normalized data to the broadcast server as indexed by Event ID. Alternatively, the content aggregator receives the external data already mapped to a single Event ID system. The broadcast server then periodically supplies the updated enhanced schedule to the client systems, as shown in FIG. 3 as block 310.

A Broadcast Server 120 (see FIG. 2) operates in conjunction with several components to create the data services, such as index log files, associated with the broadcast television content stream. Various content aggregators 202 generate normalized data feeds corresponding to various events or pieces of content that may be available for viewing. For example, a Sports Content Aggregator 202(1) receives various data feeds based on events that occur in the televised games of interest from external Sports Data Providers 214(1). The data feeds include, for example, sports status real-time data, sports statistics and editorial data from Internet data services such as STATS, Inc™, the Associated Press™, and the like. The Data Providers 214 may be external to the Content Aggregator 202 or portions may be a part of the Content Aggregator 202.

Additional content aggregators, such as a Movies Service Provider 202(2), a News Content Provider 202(3) and a Music Service Provider 202(4), provide output data streams to the Broadcast Server 120. That is, for each television program, movie, or other piece of content, the appropriate service provider creates an Event Identifier for each program, event, or piece of content and associates that Identifier with content related to that program, event, or piece of content. Then, meta-data related to the movie is also assigned the same Event ID. Such data may include movie reviews, trailers, previews, interviews, etc. In News, events may be assigned Event IDs, such as an election scandal, an AIDS conference, a legislative debate, or the like. Then, meta-data associated with the event is also assigned the same Event ID, including web sites relating to the event, video clips, etc. For Music, a database of songs and artists each may receive an Event ID, and the meta-data relating to songs and artists receive the same Event ID. Other Service Providers 402 for different categories similarly create Event IDs that associate the programs, events, and contents related to their category with Event Identifiers.

The modular architecture employed in this embodiment permits the Broadcast Server 120 to route domain specific television schedule data received from the Service Providers 202 in the same fashion. Also, the Broadcast Server 120 may customize the schedule data to a specific viewing location. For example, the Broadcast Server is able to match the enhanced data to any changes in local channel lineups since the schedule information is updated periodically. The Broadcast Server 120 performs additional localized functions with respect to the normalized data streams received from the Service Providers. However, modularization of these server components is optional.

The Broadcast Server 120 transmits the enhanced and normalized data streams to the client viewers for enhancing the viewing experience, as shown in FIG. 3 as block 320. In one embodiment, the Broadcast Server 120 also performs the function of the Content Aggregator 202. In this embodiment, the Broadcast Server 120 receives from the Sports Provider (or other provider) 204 heterogeneous data associated with different enhanced IP data from a variety of sources, television schedule information from a variety of sources (such as a cable provider, a satellite provider, a TV listings service such as the Tribune Media Service, or the like), and create a single sports or other themed schedule that relates the enhanced IP data with the different program listings. In an alternate embodiment, the different Content Aggregators 202 create enhanced theme schedules by issuing calls to a centralized TV listings database to extract the TV listing information and then maps the extracted TV listings to the Event Ids to create an enhanced schedule, which is then transmitted to the Broadcast Server 120 and ultimately to the clients.

For creating data streams with indexed information that may be transmitted to one or more client systems, the Content Aggregator first creates and transmits an enhanced schedule to the Broadcast Server 120. Next, the Content Aggregator generates a log of indices according to predetermined rules that apply to particular program. In the case of a sporting event, the indices are created from the various data feeds provided by the Sports Data providers 214, and include data concerning game play such as when a ball is snapped, when a time out is called, and the like. Then, by way of example, to index a game, the Content Aggregator 202 creates XML representations of game segments according to certain predefined game rules. Other content providers, such as STATS Inc.™, may create the indices manually or with the use of an authoring tool.

In accordance with the invention, the event logs are sometimes collected and transmitted to the client systems as a file or a collection of files. Although many formats may be used, in one embodiment the Content Aggregators 202 create index files including XML-based event logs in accordance with a defined schema corresponding to various desired entry and exit points in the television broadcast programming, such as to mark the beginning and ending and/or elapsed time for a news segment of a particular theme or to mark the beginning of a play or highlight in a football game. The index file also includes various control data and application programming data.

For each program index file, a plurality of meta-data entries identifies various features of the file. In an example concerning the indexing of news highlights of a particular type, such data includes a category (news), a subcategory (World), a type (Mid-East), the identification of other useful information that may be used to filter the segments, and a time stamp. In addition, metadata concerning an associated Application file, in this case a file written in a markup language such as an HTML file, are included in the meta-data entries.

In addition to the specific event logs concerning the program, the Content Aggregators 202 create additional information concerning the program with arguments in the tagged event entries corresponding to such information. In addition, a description tag permits inclusion of additional information concerning the event as desired by the service provider.

Thus, the Content Aggregator captures event logs concerning segments of video data, as shown by a block 316 in FIG. 3. To capture these logs, game-specific and/or program-specific algorithms and rules may be applied to the televised event create different levels of game segments. Thus, in an example of an indexed football game, the aggregator generates an event log whenever any play results in a yardage gain of more than 20 yards, upon the occurrence of a turnover, and/or other upon the occurrence of important events such as scoring plays. These event logs are processed by a client application to enable viewing of highlights or other game segments of the same game or different games by intelligently jumping to the location in the recording associated with the event log. Other content may be included in the application to create a new experience for the viewer.

In another example, the content aggregator creates indexes with respect to a broadcast game show. In this example, an index point may be created after a question. An application controlling play back of the video segment presents a User Interface that queries the viewer for a response to the question. Thereafter, the application may transfer to a further indexed video segment to obtain the answer to the question.

In addition to processing various data feeds from Data Providers 214, the Content Aggregators create event logs or DVR indices by parsing a video stream in one or more ways (see block 318 in FIG. 3). For example, the Content Aggregator will parse Close Captioned data from the video stream for the desired program. Using the Close Captioned data, the Content Aggregator then builds an index file to transmit to the client systems. Alternatively, or in addition, the Content Aggregator uses ATVEF data to intelligently build an index file based on a received video stream. The Content Aggregators are optionally configured to intelligently parse a received video signal based on a search for certain transitions between video frames.

By capturing such event logs, the Content Aggregators 202 create a series of XML representations corresponding to appropriate index points or break points and the like in the various broadcast programs. These event logs are packaged as an index file representing the program or event.

The Content Aggregators 202 also build and/or transmit one or more application programs to enable the client systems to present a custom user interface. Thus, collections of recorded video content may be aggregated from different, sometimes disparate video sources, categorized, and then displayed in a unique fashion. For example, the application program may operate to receive viewer selection of a particular category and cause a list of recorded video content related to the category to be displayed. Upon viewer selection, the selected video data is played back by appropriate DVR play back apparatus.

In the above example, the Playback Application is written in a markup language, such as HTML or FLASH 5 from Macromedia, Inc. As explained below, the application sometimes includes scripting code and other control data providing additional enhancements such as the presentation an icons and the like.

In accordance with one aspect of the invention, the content may be indexed, aggregated and supplied over the network either in real-time or after the program has been broadcast. In the latter case, the Content Aggregators performs various post-processing functions with respect to the index file to provide further enhancements. In one mode, the invention permits playback of previously viewed programs in various modes, such as active game play only, playback of specific player participation across several games and/or teams, or playback of other highlights according to the created game indices and associated application program. In the case of an indexed game show, this may include creating entry or decision points in the programming in which a User Interface may be inserted by the application program. Thus, the created application may provide an interactive program for the viewer based in part on indexed prerecorded video content. The application may even enable seamless transitions between various video recordings that are aggregated into a movie. This provides alternative endings of a movie based on user input at the beginning or at the same entry point or even at different entry points of the movie.

Such enhancement data is transmitted to a client system where it is associated with the video recording obtained by the client system or transmitted to the client system together with the enhancements. This permits one or more playback modes such as playback in the context of an entirely new application program that uses previously recorded video content to create a different viewer experience. While the invention has been described in conjunction with a broadcast client-server architecture, it should be understood that the enhancement data may alternatively be downloaded by the Client System from an Internet web site, via e-mail or through any other transmission media. Similarly, the video content may be obtained from various sources. For example, it may be obtained from a storage device such as a DVD which is accessed by the Client System. Alternatively, the video content may be downloaded from the Internet or from some other file or content server. Finally, the video content may be obtained via streaming media from a server either through the Internet or otherwise.

The Client System receives and processes the transmitted data streams, where they are output, together with video, on a display device 122. As explained below, the display device 122 is segregated into various display areas including a viewer area 122a for displaying a currently playing video content, and in some embodiments a dashboard display area 122b that may be used to present a listing of similarly recorded video content that is related to a specific theme. Other display areas such as area 122c provide information such as purchasing information, alerts for other programming and the like.

The Client System 100 may employ multiple digital or analog tuners to receive the transmitted programming and enhanced content. The use of multiple digital tuners provides numerous advantages in implementing the present invention. For example, television controls may be provided to further enhance the viewing experience.

To play back video content in accordance with the invention, the client system executes one or more application programs. In a preferred Audio/Video Entertainment platform or architecture, a run-time environment exposes a set of application programming interfaces (APIs) to allow playback application programs control the playback of the recorded video, including starting, stopping, and skipping to any portion of the recorded program. The application programs may access one or more underlying data engines for processing the received content, as explained in the above referenced patent applications. For program indexing, a DVR data processing engine extracts indexing information from the received data stream or from local storage when an indexed file is resident at the Client System.

Thus, an application related to delivery of related News segments may be created to provide viewer indication and selection of currently recorded story segments according to a thematic topic. As with the game indexing function performed with respect to the sports application program, a News application may employ the DVR engine to process indices for news programs or related program segments. In one embodiment, the application processes video recordings and associated indices that originate from different sources, such as related news programs of different channels. In this example, the news program, either currently being broadcast or previously broadcast, has been previously processed and logged. An Event ID was assigned to the video content that is mapped to the local channel from which the video content was recorded.

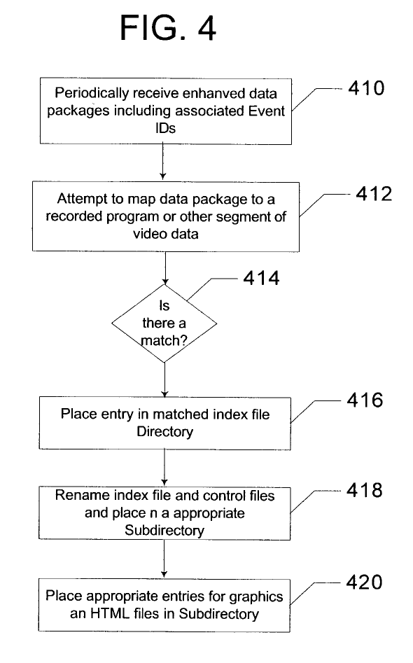

FIG. 4 is a flow diagram illustrating various steps that are executed by the Client System to aggregate the received stream with DVR enhancements. The Client System processes received video data index files, Playback Application files and other data services to provide a unique viewer experience. In a preferred embodiment, the Client System uses a DVR data processing engine along with one or more received software components to create a Playback application. Generally, there are two types of Playback Applications: (1) applications that are associated with a particular event, such as the Super Bowl; and (2) applications that span multiple recordings, such as an application that displays segments from multiple News programs. The Playback Applications that are specific to a particular event, such as a sporting event or sports highlight program, are typically deleted when the user deletes the recorded video content. On the other hand, Playback Applications that are thematic and span across multiple recordings may persist after the user deletes the recordings. Examples of the latter types of applications may include an application that plays preview segments of movies that are available on various pay-per-view or movie channels, video content concerning a particular celebrity or other individual of interest. Thus, the Playback Applications may aggregate video data from the same or related programming or from disparate sources.

The received DVR index files are associated with a video file stored on the client system storage medium in various ways. In one example, various data packages, each of which may contain program index files, are downloaded to the client system. These data packages typically include a program DVR index file and a Playback Application (or a pointer to a Playback Application). As explained above, the DVR index file contains event index logs for the program. A Playback Application is an application that generally provides and enhanced user experience. It may include user interface elements and scripting code to present a user interface to the user to facilitate playback control of a recorded video program. When the Playback Application is launched, the client operating system passes control from the client operating system to the Playback Application. The Playback Application can sometimes present a user interface, or load and invoke other files to display alternative display elements that make up the user interface to the Playback Application. In addition, it controls playback of audio and video content. Thus, it can start, stop, slow down to half-speed or pause, or fast forward and jump to different portions in the recorded video. In a preferred embodiment, the Playback Application is written in markup language, such as HTML or FLASH 5 from Macromedia, Inc., and optionally contains scripting code such as JavaScript, Perl or Visual Basic. The Playback Application may optionally contain, or point to, code written in other languages such as C++, Java, or C#.

The system maintains a meta-data directory of recorded programs, index files and control files. A storage media on the Client System contains a meta-data directory for this purpose, having entries for the recorded programs. The recorded video data for the recorded programs are stored in another partition of the storage medium. In addition to entries for the recorded programs, the meta-data directory also contains an entry for an associated index file and an entry for an associated application program, which is placed in the directory as a result of a match with the program entry.

When the package is downloaded, a data package handling service residing on the client system is called to map the received data package to a recorded program, if a recorded program exists. The package handling service first determines whether a corresponding program has been recorded. This association may be performed various ways, such as with an API that permits the service to specify a program and its parameters in a manner that permits the client system to determine whether the program has been recorded. For example, the API may use an Event ID or any other identification information uniquely associating the package with a recorded program. As explained above, the Event ID (or other identification) may be obtained by mapping heterogeneous Ids previously assigned to the package into a single homogeneous Event ID system, or the Event ID may be derived from or be the same as a pre-existing universal ID system. In this instance, arguments to the method that performs this function include scheduling and type information concerning the program, and an Event ID.

When a match occurs, the package handling service places an entry for the matched index file, and any other associated files, in an Indexed File directory. The service creates a new directory entry for the indexed program and places that entry into the Indexed File directory. The Playback Application, and the index files, are associated with the recorded video content and stored on the hard disk. The Client System may optionally receive other related data to enhance the user interface for the indexed program. For example the Client System may receive image and graphics files and additional HTML files and place entries for these into appropriate subdirectories for the indexed file. The related files are also stored on the storage medium.

Other data packages received by the client system are handled in a similar manner. Thus, if the packaging handling service is called to handle the next data package, and no match is found because no corresponding recorded program entry existson the storage medium, the transmitted data package is discarded. In one preferred embodiment, the downloaded data packages include index files, playback applications and other associated files. However, playback applications may be downloaded with the index data, or they can already be installed on the Client Operating System or they can be downloaded at some other time. Alternatively, users can send these files to other locations via email or the like.

In accordance with the Playback Application, the event indices are matched with video index points of a recorded program during playback of the recording. This may be implemented as various APIs with interfaces that are exposed to the Playback Application to control playback of the recorded video. When the viewer selects playback of the recording, the recorded program is located. Based on the entries in the meta-data directory, the Playback Application may call a DVR engine to perform various operations, such as to start, stop, pause, fast-forward, rewind and go to a particular location, under control of the Playback Application. In this example, the Playback Application loads the indices from the associated DVR index file. The Playback Application typically includes code (such as scripting code) to initiate certain operations such as to begin playback. Among other things, the Playback Application builds data structure including the events obtained from the associated DVR index file. When the viewer provides an input corresponding to the selection of an event such as a skip to the next play, the Playback Application commands the DVR engine to perform various actions. For example, based on the viewer's actions, the Playback Application may command the DVR engine to perform a lookup in the event data structure to obtain a time index for the nextevent. The time index is a time offset from the beginning of the recorded program. Since time sequence information is also provided with the stored video file, the DVR engine then determines the appropriate location in the video corresponding to the time offset in the event data structure and causes the system to begin playback at that location. Other event indices are handled in the same manner, namely, by obtaining a time offset or index from the beginning of the program and locating the appropriate video location corresponding to the time index.

In addition to information concerning the starting point of each tagged event, the indices received by the client system preferably contain other tagged data. In the football example described above, such additional tagged data includes the type of play, yards gained, athlete name, and a description of the event. Thus, at the client system, different levels of personalization can be applied to the tagged event data in order to display preferred data to the user. For example, the Playback Application may apply filtering techniques such as XML transforms to the data to allow the user to view only preferred data that is a subset of the recording, and to even more intelligently skip to the parts of the DVR recording of interest to the user during playback.

According to the invention, various additional components are downloaded to the client system to enable creation of a Playback application that is associated with the DVR index file. Thus, the Client System may maintain a meta-data directory that includes entries corresponding to the recordings stored on the storage medium. When a video recording includes an associated downloaded program DVR index file, the meta-data directory also contains entries for various components of an associated Playback application. In addition to the index file entry, other subdirectories may include entries for related files. These may include picture files such as GIF files or JPEG files, JavaScript code, and HTML pages.

The operating system typically passes control to the Playback Application when the application is launched. The entry point may be a specified HTML page. The Playback application can be implemented as a series of HTML pages, scripting code such as JavaScript, GIF files, JPEG files, FLASH code, C or C++ code, or even one or more Dynamic Linked Libraries (DLLs) that are compiled for an A/V entertainment platform. In addition to receiving the various files as a downloaded package, the Playback application can itself decide the files to be loaded and displayed to the user.

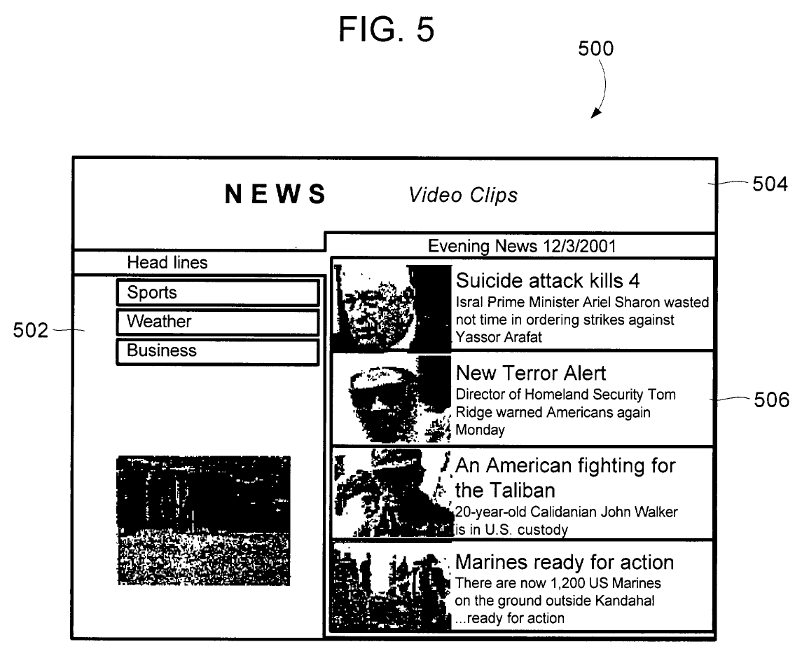

FIG. 5 illustrates an exemplary User Interface or display rendered by an application program or programs using the data services according to the invention. In this embodiment, the User Interface 500 presents several display areas: a navigation area 502, and a play-list area 504. The play-list in this case is a scrolling list that includes entries such as an entry 506 of indexed video content. These play-list entries correspond to context sensitive locations in the recorded video file, namely, the beginning of the news item. Selection of one of the entries in the play-list permits the viewer to play back the corresponding item in the recorded news program.

The video content is captured from either independent sources or channels or from the same channel. In any event, it relates to a common theme, in this case a collection of News events occurring on a particular evening. The entries are provided with a thumbnail graphic as well as descriptive information concerning the captured video content.

In addition to News stories, application programs may be tailored to aggregate indexed segments of video data relating to other content or stories. For example, the invention may be used to enable the viewer to skip over parts of a program or to view highlights and other information concerning a particular sporting event. It should be understood, however, that the invention is not limited in any way to the specific manner in which the various window elements or play-lists, are located on the screen in the described embodiments.

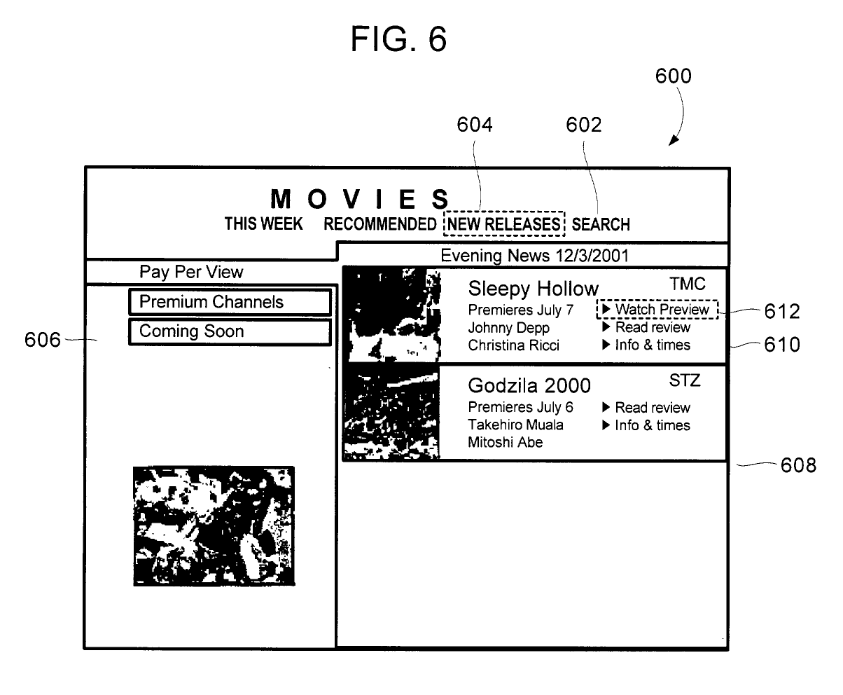

FIG. 6 shows a different User Interface for a Playback application that provides a search and preview guide for next programs based on an application that uses previously downloaded and stored indexed video content. In one embodiment, the application may facilitate DVR recording or similar action of the previewed program. In this embodiment, the search guide locates movie offerings, such as movie channel or pay-per-view offerings being provided by the service. Currently, viewers can obtain such information from channels that are dedicated to playing previews. However, there is no practical way to access only a preview or previews of interest.

According to the invention, the Movie Service captures and indexes video content as a carousel or jukebox model in which each segment corresponds to brief preview of new movie releases. The service also builds index files that identify the movie preview clips and supplies these files to the Client System. For example, such index files could be provided on a periodic basis to the Client System. Other graphics and control data are supplied to the Client System as well. As shown in FIG. 6, the User Interface includes a coarse navigation bar 602 or area that selectable buttons to permit navigation through various features of the service, such a “New Releases” button 604. The User Interface optionally includes a navigation area 606 for movie preview types, such a “Pay Per View” channels being offered by the service. The previews are displayed as a play-list 608 with one or more information areas such as area 610 that provide graphics and information concerning a movie preview. The information area 610 also includes a viewer selectable “Watch preview” button 612 that provides a link to the corresponding movie preview segment. In response to a selection of the “Watch preview” button, the application causes the indexed segment of preview video data to be displayed.

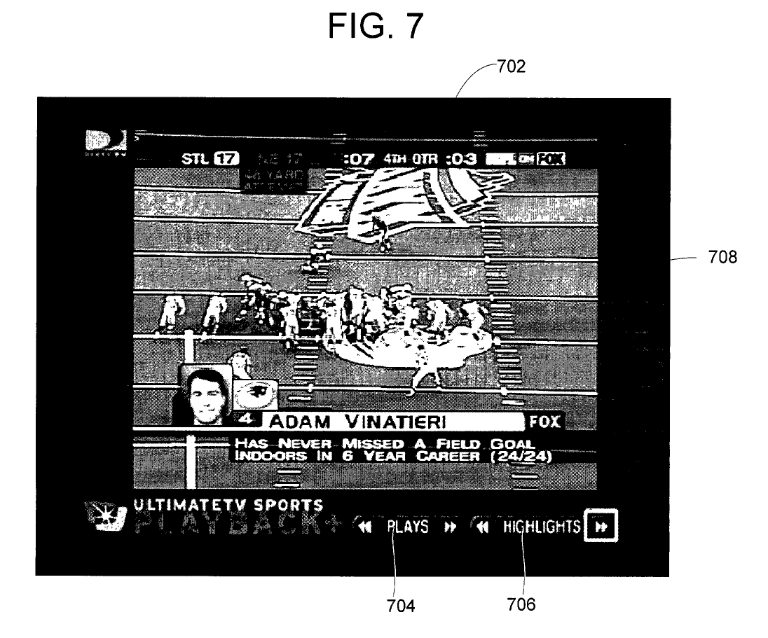

FIG. 7 illustrates a User Interface for a Playback application that was created to facilitate playback of a football game that was previously recorded. The Sports Service captures and creates indexes of the football game as is described in the above prior applications. The service also builds index files that identify, among other things, highlights and the beginning of plays in the game. In addition, the service creates a Playback Application. These files are transmitted to the Client System. Other graphics and may be supplied to the Client System as well. The User Interface includes a game status indicator 702 that provides information concerning the current status of the recorded game. The User Interface optionally includes a first navigation area 704 that includes user selectable buttons to permit the user to skip between plays that are indexed in the recording. A second navigation area 706 permits the user to navigate between recorded highlights. As explained in the earlier referred-to patent application, such highlight indexes are created according to game rules applied to the recording, such as by plays that exceed a certain yardage or that have some importance to the outcome. In addition, display area 708 permits the recorded game to be displayed.

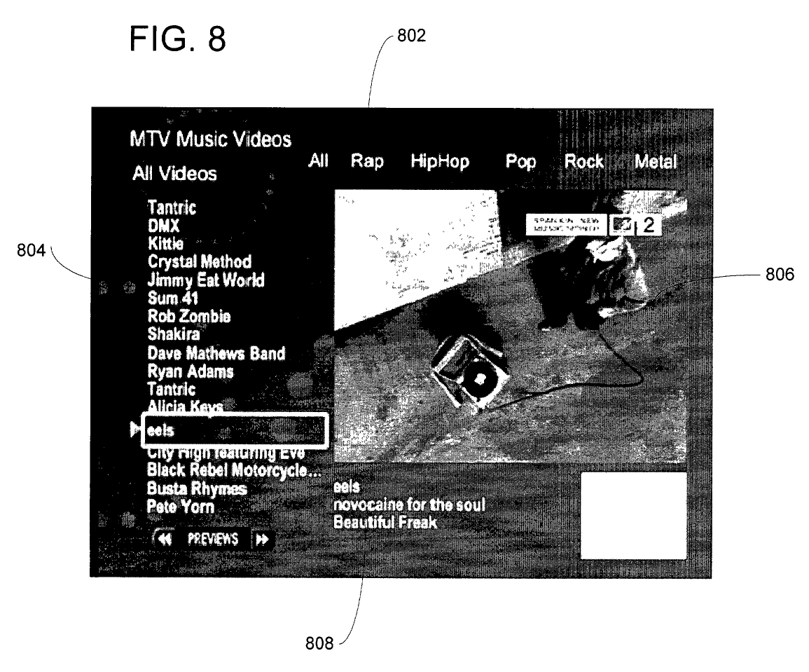

FIG. 8 shows a User Interface for a Playback application that provides a play-list for music videos that are stored on the Client System. In this case, a Music Video Playback Application presents a play-list of prerecorded and indexed music videos that are aggregated in a logical fashion. In one embodiment, the Music Video Playback Application uses indexes obtained from a music service or the like. The service also uses various tags with respect to the music videos that identify, among other things, the artist, genre, “sounds like,” or any other suitable filter mechanism. Other graphics and data are supplied to the Client System as well.

As shown in FIG. 8, the User Interface includes a coarse filter display area 802 including user selectable buttons such as “Rap,” “HipHop,” “Pop,” “Rock” or “Metal.” Upon receipt of user selection of one of these buttons, the Playback Application filters a play-list 804 of music video titles that is presented in a display window or area of the screen. In the example, the user has selected an artist from the play-list 804, and the Playback Application causes the Client System to jump to the beginning of the corresponding stored music video content. The music video is played back in display window 806. A display window 808 below the display window 806 presents additional information concerning the music video such as the title of the artist, the song title, and the Compact Disk or album.

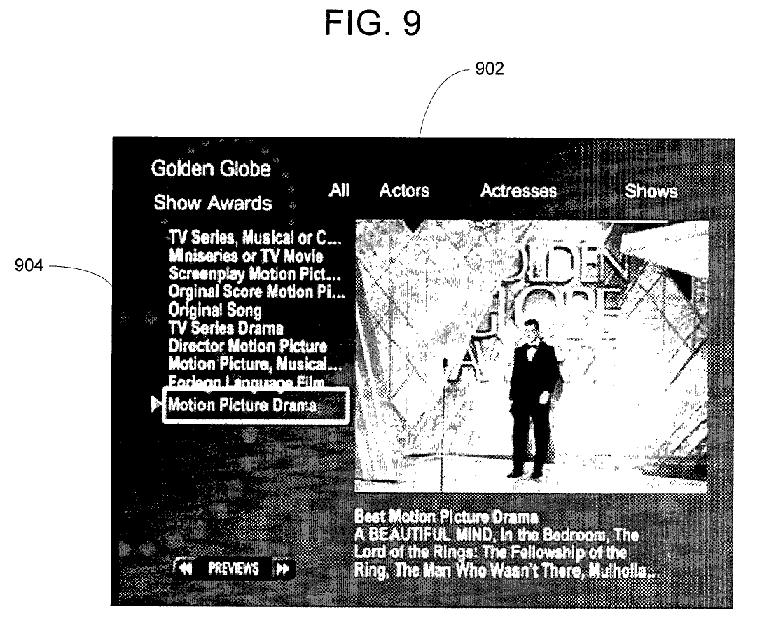

FIG. 9 illustrates a User Interface for a Playback application that was created to facilitate playback of an Awards show that was previously recorded. An entertainment service captures and creates indexes of the awards show. The service also builds index files that identify, among other things, the various awards in the program. In addition, the service creates a Playback Application. These files are transmitted to the Client System. Other graphics and may be supplied to the Client System as well. The User Interface includes a display window 902 with selectable buttons to permit the user to filter various categories of the show, such as by actors, actresses and/or shows. The User Interface also includes a display window 904 that presents a user selectable play-list to permit the user to skip between awards and segments in the Awards show. In the example, the user has selected “Actors” from the display window 902 to filter only awards that actors receive in the play-list 904.

One unique feature of this Playback Application is the ability to receive user input to jump within portions of the selected video data segment. For example, if the user selects the award for “Motion Picture Drama” by clicking on that entry in the play-list 904, the application jumps to the beginning of the award where the presenter first appears on stage. If the user clicks a second time, the application jumps to the portion of the recording where the award winner is announced. If the user clicks a third time, the recording jumps to the portion where the winner gives his or her acceptance speech. This permits a degree of user control over the content that is viewed during playback and that which is discarded.

Thus, the Playback application may be used with video content from a DVR recording of a single program or by associating multiple indexed recordings from independent sources. Indeed, in one aspect of the invention, an application program is be used to collect portions of video data from disparate sources. That is, if the user has a preference for obtaining information and video concerning an event, such as the Academy Awards or other celebrity event, then an application program may be used to obtain video content related to such event by matching tagged video data with the preference, such as with Event IDs that may be associated with the event. Alternatively, if the viewer desires to watch a particular athlete in multiple events, the invention could be used to implement an application that accesses indexed data from all such events to provide the specific video playback desired by the user.

In addition to game index files that are used to enhance an entire program, such as an entire football game in the example given above, event logs may be transmitted to the client system in real-time to enhance a televised program as it occurs. That is, the DVR indexing engine may operate to build an event data structure concerning a program as the program is broadcast. In this instance, the indices are associated with video content stored in a pause storage buffer, and may be used to index the program whether or not it is permanently recorded. The DVR indexing engine then operates to locate the time index in the event data structure and the corresponding video location in the same manner as described above. Thus, while delivery of the Playback application has been described above in connection with embodiments in which enhanced content is received after the broadcast program is recorded, the invention may also be implemented to permit user interaction based on enhanced content received during the broadcast program, and the application program is delivered at a later time.

In the currently preferred embodiment, the DVR enhancements are applied to the recording of an entire program. Thus, the video recording is not copied or altered. However, the client system may operate to process and enhance the video recording in various ways. For example, the client system may edit the recording and resave an edited version of the recording according to viewer preferences.

The described invention has various advantages and features. In prior systems, recorded video content is conventionally played back in a straight-forward and limited manner. In contrast, the present invention permits such data to be combined with indexes to provide new and interesting programming to the viewer. This permits a Playback Application, based on user actions, to jump to specific locations of recorded video content in an intelligent fashion in accordance with meta data associated with tagged entries in the recorded content.

Accordingly, an enhanced television service meeting the above objectives has been described. It should be understood, however, that the foregoing description has been limited to the presently contemplated best mode for practicing the invention. It will be apparent that various modifications may be made to the invention, and that some or all of the advantages of the invention may be obtained. Also, the invention is not intended to require each of the above-described features and aspects or combinations thereof, since in many instances, certain features and aspects are not essential for practicing other features and aspects. Accordingly, the invention should only be limited by the appended claims and equivalents thereof, which claims are intended to cover such other variations and modifications as come within the true spirit and scope of the invention.

What is claimed is:

1. A method for playing back video content obtained from independent sources in an audio/video entertainment system comprising the steps of:
recording video content received from independent sources;
categorizing the received video content;
receiving video indices associated with the recorded video content;
displaying categories of the recorded content wherein receiving a selection of a category displays a list of items of recorded video content related to the category;
receiving a selection of one of the listed items; and
playing the selected item of recorded video content in accordance with the associated video indices.

2. The invention as in claim 1 wherein the categorizing step further includes the steps of:
receiving video content listing data;
extracting an Event Identifier associated with the received video content;
matching the Event Identifier with the video content listing data; and
categorizing the received video content based on the video content listing data.

3. The invention as in claim 1 wherein the video content is obtained from different broadcast television programs.

4. The invention as in claim 1 wherein the video content is thematically categorized.

5. The invention as in claim 4 wherein the video content is categorized as News items relating to a particular topic.

6. The invention as in claim 4 wherein the video content is categorized as Sports highlights.

7. The invention as in claim 4 wherein the video content relates to a celebrity event.

8. The invention as in claim 7 wherein the celebrity event is an awards show.

9. The invention as in claim 4 wherein the video content relates to previews of a particular theme.

10. The invention as in claim 1 wherein the video content is obtained from a storage unit accessed by the entertainment system.

11. The invention as in claim 10 wherein the storage unit is a DVD unit.

12. The invention as in claim 1 wherein the video content is downloaded from the Internet.

13. The invention as in claim I wherein the video content is downloaded as streaming media from a server.

14. A method for creating an interactive program having one or more segments of video data in an audio/video entertainment system comprising the steps of:
receiving and storing video data;
receiving event log data corresponding to entry points in the video data to thereby define segments of video data;
executing an application program defining rules for playing back the segments of video data;
requesting user input at a discrete entry point in one of the segments of video data in accordance with the defined rules;
playing a different video segment in accordance with a response received from the user.

15. The invention as in claim 14 wherein the application program relates to a movie.

16. The invention as in claim 14 wherein the application program creates an interactive game.

17. The invention as in claim 16 wherein the interactive game is based on a television program.

18. The invention as in claim 14 further comprising the step of
matching an Event ID assigned with the event log data with an Event ID assigned to the stored video data; and
associating the stored video data with event log data when the Event IDs are the same.

19. The invention as in claim 17 further comprising the step of
discarding the event log data when the Event ID associated therewith does not match an Event ID associated with the stored video data.

20. The invention as in claim 14 further including the steps of
deleting the stored video data; and
automatically deleting the event log data when the stored video data is deleted.

21. The invention as in claim 14 further including the steps of
deleting the stored video data; and
automatically deleting the application program when the stored video data is deleted.
